(19) United States
(12) Patent Application Publication
(10) Pub. No.: US 2006/0069630 A1
(43) Pub. Date: Mar. 30, 2006

(54) Coding apparatus and method

(76) Inventor: Colin McCavitt, Scottsdale, AZ (US)

Correspondence Address: WEISS & MOY PC, 4204 NORTH BROWN AVENUE, SCOTTSDALE, AZ, 85251, US

(21) Appl. No.: 10/955,675

(22) Filed: Sep. 30, 2004

(51) Int. Cl. G07F 19/00; H04M 15/00

(52) U.S. Cl. 705/34

(57) ABSTRACT

An apparatus and method for permitting the scanning of database information from a data-containing document. The data-containing document may be a bill, invoice or fillable form, and contains both database information and bar code symbology containing the database information. A user needing to input the database information, instead of doing so manually, may do so by scanning the bar code symbology.

### FIELD OF THE INVENTION

The present invention relates to code symbologies and methods therefore and, in particular, to bills and fillable forms having data containing code symbologies thereon to ease data entry processes.

### BACKGROUND OF THE INVENTION

Individuals and businesses receive invoices for all types of goods or services. For example, a typical individual might receive bills for phone, gas, electric, water, cable, and Internet services on a monthly basis. Businesses might receive similar bills, as well as other bills for goods and services purchased.

It is typically desirable for data included in a bill, including for example the bill amount, date, and name of payee to be inputted into some type of accounting or expense-tracking software, such as QUICKBOOKS®. Typically, this occurs through a manual process, with a person typing the data into a computer keyboard and thereby entering it into a desired program.

Another area where manual data entry occurs concerns fillable forms, such as those used by the government. For example, a person applying for a passport can complete a fillable form containing an application for a passport. The filled form is then transmitted to the government, where the data contained therein can then be manually input into a database.

The present invention is directed to an apparatus and method utilizing coding symbology to permit previous manual data entry processes to become automated.

### SUMMARY OF THE INVENTION

In accordance with one embodiment of the present invention, a scannable data-containing document is disclosed comprising, in combination: data-containing document; database information displayed on the data-containing document; and bar code symbology on the data-containing document; wherein the bar code symbology contains the database information.

In accordance with another embodiment of the present invention, a method for permitting the automated inputting of database information is disclosed comprising the steps of: providing a data-containing document; one of providing and receiving database information on the data-containing document; providing bar code symbology on the data-containing document; wherein the bar code symbology contains the database information; and scanning the bar code symbology to extract the database information.

### BRIEF DESCRIPTION OF THE DRAWINGS

FIG. 1 is an example of an invoice containing code symbology thereon.

FIG. 2 is an example of a fillable form containing code symbology thereon.

### DETAILED DESCRIPTION OF THE PREFERRED EMBODIMENTS

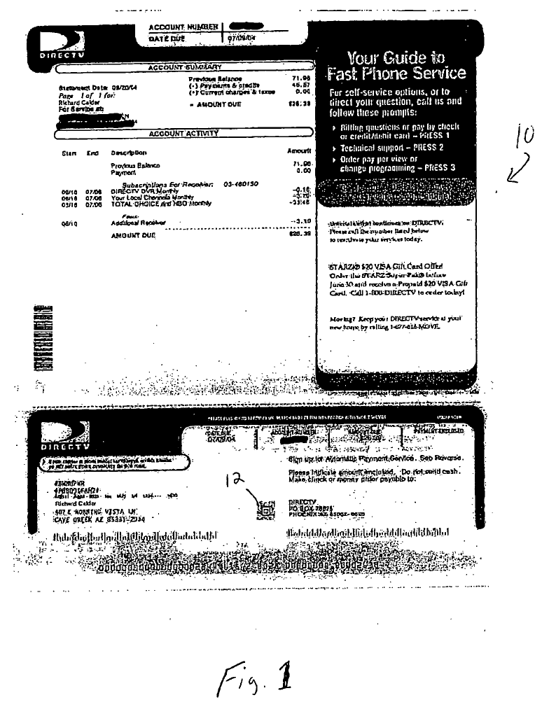

Referring first to FIG. 1, an example of a bill 10, in this case a satellite television bill, is provided. The bill 10 includes thereon information including the identity of the payee, the date of the invoice or “statement date,” an amount due, and other information that a recipient of a bill 10 might wish to record—referred to herein as “Database Information.” Located on the bill 10, in this embodiment, is an area of bar code symbology 12.

The bar code symbology 12, in this embodiment, is Aztec Code. Aztec Code is a high density two-dimensional matrix style bar code symbology that can encode up to 3750 characters from the entire 256 byte ASCII character set. The Aztec Code symbol is built on a square grid with a bulls-eye pattern at its center. Data is encoded in a series of “layers” that circle around the bullseye pattern. Each additional layer completely surrounds the previous layer thus causing the symbol to grow in size as more data is encoded, while the symbol remains square. Aztec's primary features include: a wide range of sizes allowing both small and large messages to be encoded, orientation independent scanning and a user selectable error correction mechanism.

It would be possible, utilizing an Aztec Code or other symbology, to encode the Database Information in the bar code symbology 12. This permits a recipient of the bill 10 to scan the bar code symbology 12, and to thereby obtain the Database Information from the bill 10 without the need for manual inputting thereof. This would greatly speed the process of inputting Database Information from a bill 10 into an accounting or other recordkeeping program.

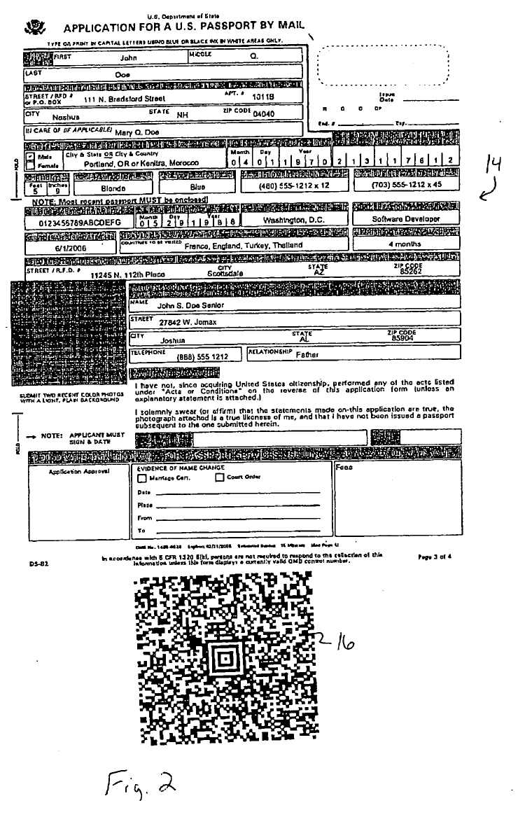

Referring now to FIG. 2, an example of a fillable form 14, in this case a passport form, is provided. The term “fillable form” as used herein refers to a form that permits a user to input information directly into the form while it is displayed on a computer screen using a computer keyboard, and without the need to print out the form and manually write in the requested information, or type it in using a typewriter. The information inputted by the user into the fillable form 14 may also be referred to herein as the “Database Information.”

In this embodiment, an area of bar code symbology 16 is generated on the fillable form 14. The bar code symbology 16, which may be Aztec Code or other code having sufficient data capacity, is software-generated and includes the information that the user has inputted into the form; i.e., the Database Information. In this fashion, a recipient of the form, such as a government agency, can electronically input the Database Information by scanning the bar code symbology 16, rather than through a manual data entry process.

As used particularly in the claims hereof, it is noted that the term “data-containing document” shall mean, and be limited to, a bill, invoice, or fillable form.

While the invention has been particularly shown and described with reference to preferred embodiments thereof, it will be understood by those skilled in the art that the foregoing and other changes in form and details may be made therein without departing from the spirit and scope of the invention.

I claim:

1. A scannable data-containing document comprising, in combination:
data-containing document;
database information displayed on said data-containing document; and
bar code symbology on said data-containing document;
wherein said bar code symbology contains said database information.

2. The document of claim 1 wherein said data-containing document is a bill.

3. The document of claim 2 wherein said database information consists of at least one of a payee name, statement date, and amount due.

4. The document of claim 3 wherein said database information consists of at least each of a payee name, statement date, and amount due.

5. The document of claim 1 wherein said data-containing document is a fillable form.

6. The document of claim 5 wherein said database information consists of information inputted into said fillable form by a user.

7. A method for permitting the automated inputting of database information comprising the steps of:
providing a data-containing document;
one of providing and receiving database information on said data-containing document;
providing bar code symbology on said data-containing document;
wherein said bar code symbology contains said database information; and
scanning said bar code symbology to extract said database information.

8. The method of claim 7 wherein said data-containing document is a bill.

9. The method of claim 8 wherein said database information consists of at least one of a payee name, statement date, and amount due.

10. The method of claim 9 wherein said database information consists of at least each of a payee name, statement date, and amount due.

11. The method of claim 7 wherein said data-containing document is a fillable form.

12. The method of claim 11 wherein said database information consists of information inputted into said fillable form by a user.
